(19) United States
(12) Patent Application Publication
(10) Pub. No.: US 2009/0013345 A1
(43) Pub. Date: Jan. 8, 2009

(54) METHOD AND EQUIPMENT FOR MONITORING TONE QUALITY OF AUDIO PLAYER AND BROADCAST SYSTEM

(75) Inventors: Chi-Shin Chen, Taipei City (TW); Hsin-Chieh Chan, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 11/852,499

(22) Filed: Sep. 10, 2007

(30) Foreign Application Priority Data
Jul. 2, 2007 (TW) 96124007

(51) Int. Cl. H04H 20/00

(52) U.S. Cl. 725/19

(57) ABSTRACT

A method for monitoring tone quality of an audio player is provided. The method includes embedding a digital watermark into an audio signal, and playing the audio signal with the digital watermark by the audio player. Then, the digital watermark extracted from the audio signal played by the audio player is compared with the original digital watermark, so as to detect relative parameters of the tone quality of the audio player.

### CROSS-REFERENCE TO RELATED APPLICATION

This application claims the priority benefit of Taiwan application serial no. 96124007, filed Jul. 2, 2007. All disclosure of the Taiwan application is incorporated herein by reference.

### BACKGROUND OF THE INVENTION

1. Field of the Invention

The present invention relates to a tone quality monitoring technique. More particularly, the present invention relates to a tone quality monitoring technique using digital watermark.

2. Description of Related Art

In the early 20th century, after telegraphy for sending radio information was invented, telephones for sending voice were also invented. Then, people found out that as electricity could send voice, it could send music as well. Thus, radios were developed.

With the progress of science and technology, more and more types of audio players have appeared in the market. Moreover, the development of semiconductor technology allows the audio players to be smaller, so that they can be carried by consumers conveniently. Currently, a wide variety of audio player products, such as FM/AM radios, CD players, and MP3 players, are available. In addition, audio players are also applied in many electronic products such as cell phones and laptop computers.

However, it has always been an important task for manufacturers to test the tone quality of audio players in production line to ensure that the audio players satisfy certain criteria. According to the prior art, manufacturers must purchase many complicated and expensive instruments to test the tone quality of the audio players, which incurs not only an increase of the manufacturing cost, but also a complicated and time-consuming operating process, so the prior art is not suitable to be performed in production line. If the tone quality is tested by ears, the testing standards are not uniform, which will cause much error.

### SUMMARY OF THE INVENTION

Accordingly, the present invention is directed to a method and equipment for monitoring tone quality of an audio player, which uses simple equipment to effectively monitor relative parameters of audio signals played by the audio player.

In addition, the present invention is also directed to a method and equipment for monitoring tone quality of a broadcast system, which monitors the tone quality of broadcast of the broadcast system.

The present invention provides a method for monitoring tone quality of an audio player, which includes the following steps. A digital watermark is embedded into an audio signal, and the audio signal with the digital watermark is played by the audio player. Then, the digital watermark is extracted from the audio signal played by the audio player, and is compared with the original digital watermark, so as to detect relative parameters of the tone quality of the audio player.

In another aspect, the present invention provides a method for monitoring tone quality of a broadcast system, which includes the following steps. A digital watermark is generated, and the digital watermark is embedded into a broadcast audio signal broadcasted by the broadcast system. Then, the digital watermark is extracted from the broadcast audio signal, and is compared with the original digital watermark, so as to monitor whether the tone quality of the broadcast audio signal is normal or not.

In another aspect, the present invention provides an equipment for monitoring tone quality of an audio player, which includes a watermark embedding module and an analysis module. The watermark embedding module generates an audio signal embedded with a digital watermark for the audio player to play. The analysis module records the audio signal played by the audio player, extracts the digital watermark, and analyzes relative parameters of the tone quality of the audio player based on the comparison between the extracted digital watermark and the original digital watermark.

In another aspect, the present invention provides an equipment for monitoring tone quality of a broadcast system, which includes a watermark embedding module and an analysis module. The watermark embedding module embeds a digital watermark into a broadcast audio signal broadcasted by the broadcast system. The analysis module records the broadcast audio signal, extracts the digital watermark, and analyzes whether the tone quality of the broadcast audio signal is normal or not based on the comparison between the extracted digital watermark and the original digital watermark.

The present invention analyzes the tone quality of the audio signal by comparing the digital watermark embedded in the audio signal and the original digital watermark. Therefore, the present invention only needs simple hardware to monitor the tone quality of the audio signal played by the audio player and the broadcast system.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a block diagram of an internal circuit of an equipment for monitoring according to a preferred embodiment of the present invention.

FIG. 2 is a block diagram of an internal circuit of an equipment for monitoring according to another embodiment of the present invention.

FIG. 3 is a flow chart of steps of a method for monitoring an audio signal according to a preferred embodiment of the present invention.

FIG. 4 is a flow chart of steps of analyzing the tone quality of an audio signal by the use of the digital watermark according to a preferred embodiment of the present invention.

### DESCRIPTION OF EMBODIMENTS

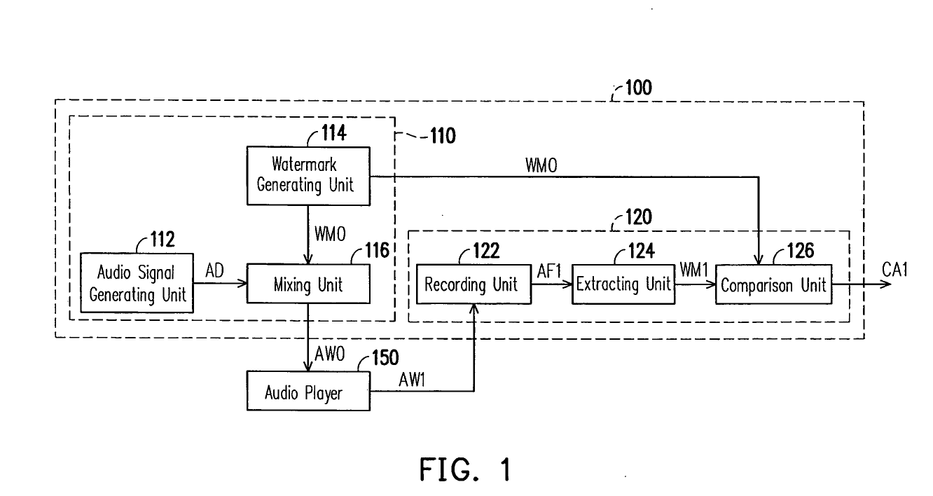

FIG. 1 is a block diagram of an internal circuit of an equipment for monitoring according to a preferred embodiment of the present invention. Referring to FIG. 1, the monitoring equipment 100 of the present invention is suitable for monitoring relative parameters e.g., frequency response, total harmonic distortion plus noise (THD+N), amplitude, frequency accuracy, and signal saturation of the tone quality of an audio signal played by an audio player 150. The quality of the audio player 150 can be determined according to the parameters. In this embodiment, the audio player 150 can be an MP3 player, a CD player, or a radio.

The monitoring equipment 100 includes a watermark embedding module 110 for generating an audio signal AW0 embedded with a digital watermark. The watermark embedding module 110 is further coupled to an analysis module 120. The watermark embedding module 110 includes an audio signal generating unit 112, a watermark generating unit 114, and a mixing unit 116. The mixing unit 116 is coupled to the audio signal generating unit 112 and the watermark generating unit 114. The audio signal generating unit 112 generates an original audio signal AD, which is sent to the mixing unit 116. In this embodiment, the original audio signal AD can be a digital audio signal designed for a proof test. Furthermore, the watermark generating unit 114 generates a digital watermark WM0, which is also sent to the mixing unit 116 to be embedded into the audio signal AD, so as to generate the audio signal AW0 embedded with the digital watermark.

Generally speaking, the digital watermark technique is mainly applied in the protection of intellectual property rights. This technique uses some processing procedures to add authentication data of intellectual property rights into digital media in various forms. The digital watermark technique is roughly classified into two types, namely, visible water mark and invisible water mark.

As the digital media embedded with an invisible digital watermark looks just the same as the original digital media, the confidentiality of watermark can be achieved. Therefore, the research on the invisible watermark has attracted more attention. In this embodiment, the digital watermark generated by the watermark generating unit 114 can be a numerical sequence, e.g., a special code, a string, or a pattern. After receiving the original audio signal AD generated by the audio signal generating unit 112 and the digital watermark WM0 generated by the watermark generating unit 110, the mixing unit 116 embeds the digital watermark WM0 into the audio signal AD, thus generating the audio signal AW0 with the invisible watermark for test.

Thus, the audio player 150 can play the audio signal AW0 generated by the mixing unit 116, and outputs an audio signal AW1. At this time, the analysis module 120 can record the audio signal AW1 output by the audio player 150, and analyze relative parameters of the tone quality.

The analysis module 120 can include a recording unit 122, an extracting unit 124, and a comparison unit 126. The recording unit 122 records the audio signal AW1 output by the audio player 150, and saves it as a recording file AF1. The extracting unit 124 extracts the digital watermark WM1 played by the audio player from the recording file AF1, and sends it to the comparison unit 126, so as to compare the digital watermark WM1 with the original digital watermark WM0. After comparing the extracted digital watermark WM1 and the original digital watermark WM0, the comparison unit 126 generates a comparison value CA1. When the comparison value CA1 is higher than a threshold value, it indicates that the tone quality of the audio player 150 is good. Otherwise, the audio player 150 may be a defective product.

Persons of ordinary skills in the art should appreciate that in other selective embodiments, the above embodiment can be realized by the use of software. Therefore, the present invention does not need expensive and complicated instruments. Instead, the present invention can only use an ordinary personal computer to test an audio player.

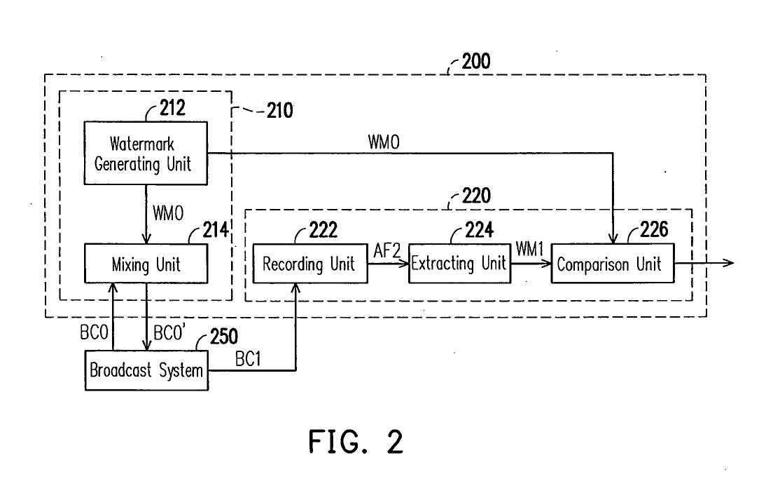

Expanding the above embodiment, the present invention further provides an equipment for monitoring a broadcast system, as shown in FIG. 2. Referring to FIG. 2, a monitoring equipment 200 of the present invention can be used to monitor the tone quality of a broadcast audio signal output by a broadcast system 250 such as an FM broadcast system, an AM broadcast system, a network broadcast system, and a network television broadcast system.

The monitoring equipment 200 also includes a watermark embedding module 210 and an analysis module 200, which have similar functions and structures as the watermark embedding module 110 and the analysis module 120 of FIG. 1. The watermark embedding module 210 includes a watermark generating unit 210 and a mixing unit 214. The watermark generating unit 210 is also similar to the watermark generating unit 114, i.e., also generates a digital watermark. In addition, the mixing unit 214 can embed the digital watermark WM0 into a broadcast audio signal BC0, so as to generate a broadcast audio signal BC0′ with an invisible watermark. Then, the mixing unit 214 sends the broadcast audio signal BC0′ to the broadcast system 250, so as to output a broadcast audio signal BC1.

The watermark in the broadcast system BC0′ is invisible. Therefore, listeners will not find any change to the broadcast audio signal BC1 broadcasted by the broadcast system 250, and can listen to the broadcast audio signal BC1 output by the broadcast system 250 normally.

The analysis module 220 also includes a recording unit 222, an extracting unit 224, and a comparison unit 226. Similar to the analysis module 120 in FIG. 1, the recording unit 222 records the broadcast audio signal BC1 broadcasted by the broadcast system 250, and saves it as a recording file AF2. The extracting unit 224 extracts the digital watermark WM1 broadcasted by the broadcast system 250 from the recording file AF2, and sends the digital watermark WM1 to the comparison unit 226. Thus, the comparison unit 226 compares the extracted digital watermark WM1 with the original digital watermark WM0, so as to monitor whether the tone quality of the broadcast audio signal output from the broadcast system 250 is normal or not.

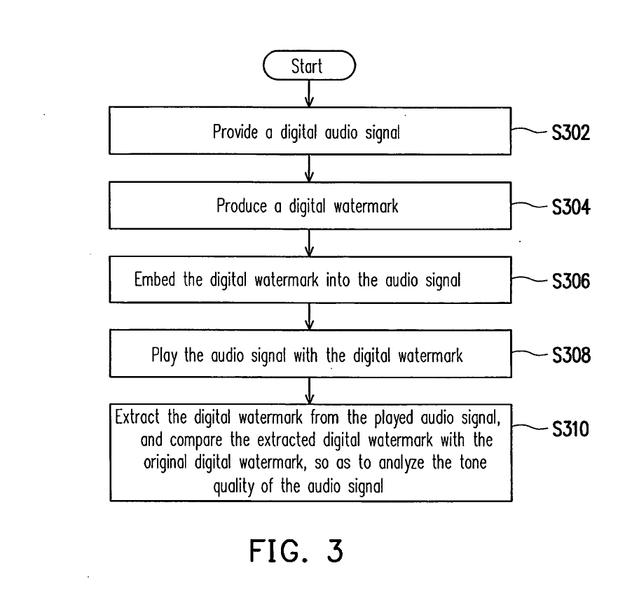

Integrating the above embodiments, the present invention further provides a method for monitoring an audio signal as shown in FIG. 3, which can monitor the audio signal output by, for example, an audio player or a broadcast system. Referring to FIG. 3, an audio signal in a digital form is provided in Step S302, and a digital watermark is produced in Step S304.

Then, the digital watermark is embedded into the audio signal in Step S306. The audio signal with the digital watermark is broadcasted in Step S308. Thus, the present invention extracts the digital watermark from the broadcasted audio signal, and compares the extracted digital watermark with the original digital watermark, so as to analyze the tone quality of the audio signal, in Step S310.

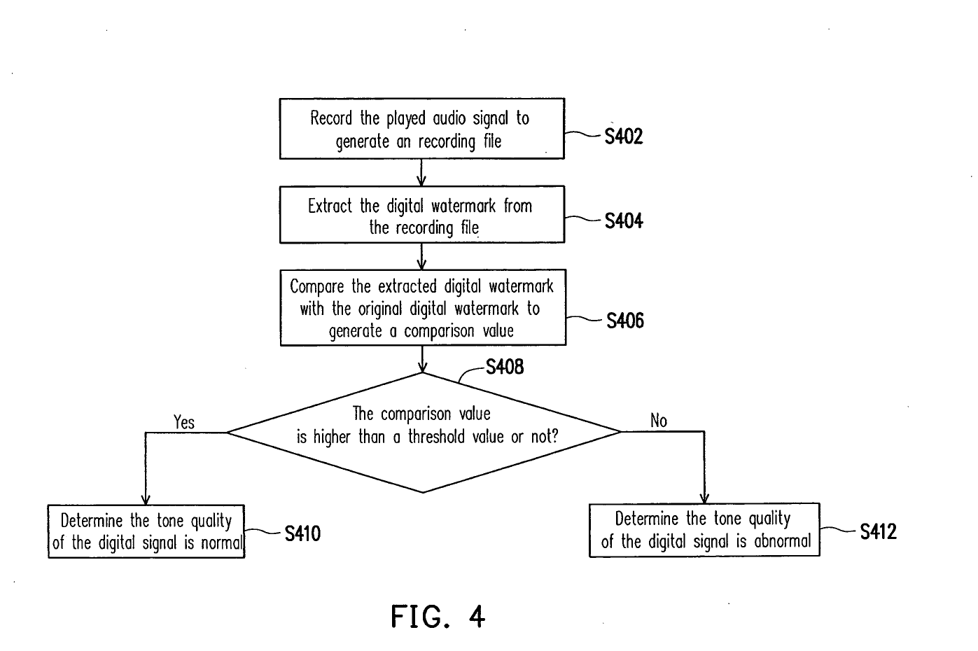

FIG. 4 is a flow chart of steps of analyzing the tone quality of an audio signal by the use of the digital watermark according to a preferred embodiment of the present invention. Referring to FIG. 4, when the present invention receives an audio signal with a digital watermark generated in steps of FIG. 3, the broadcasted audio signal is recorded to generate a recording file in Step S402. Then, the digital watermark is extracted from the recording file in Step S404. After that, the extracted digital watermark is compared with the original digital watermark to generate a comparison value in Step S406. At this time, the comparison value is determined to be higher than a threshold value or not in Step S408.

When the comparison value is higher than the threshold value (i.e. “Yes” in Step S408), it indicates that the tone quality of the audio signal is normal (i.e. Step S410). On the contrary, when the comparison value is lower than the threshold value (i.e. “No” in Step S408), it indicates that the tone quality of the audio signal may be abnormal (i.e. in Step S412). Thus, engineers can easily determine whether the audio player or the broadcast system is normal or not without using the complicated and expensive technique.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for monitoring tone quality of an audio player, comprising:
embedding a digital watermark into an original audio signal;
playing the audio signal with the digital watermark by the audio player; and
extracting the digital watermark from the audio signal played by the audio player, and comparing the extracted digital watermark with the original digital watermark, so as to detect relative parameters of the tone quality of the audio player.

2. The method for monitoring tone quality of an audio player as claimed in claim 1, wherein the step of extracting the digital watermark and comparing the extracted digital watermark with the original digital watermark comprises:
recording the audio signal played by the audio player, and generating a recording file;
extracting the digital watermark from the recording file, and comparing the extracted digital watermark with the original digital watermark, so as to generate a comparison value; and
determining playing quality of the audio player according to whether the comparison value is higher than a threshold value or not.

3. The method for monitoring tone quality of an audio player as claimed in claim 1, wherein the original audio signal is a digital audio signal.

4. The method for monitoring tone quality of an audio player as claimed in claim 1, wherein the relative parameters of the tone quality of the audio signal comprise frequency response, total harmonic distortion plus noise (THD+N), amplitude, frequency accuracy, and noise saturation.

5. The method for monitoring tone quality of an audio player as claimed in claim 1, wherein the digital watermark is a numerical sequence.

6. A method for monitoring tone quality of a broadcast system, comprising:
generating a digital watermark;
embedding the digital watermark into a broadcast audio signal broadcasted by the broadcast system; and
extracting the digital watermark from the broadcast audio signal, and comparing the extracted digital watermark with the original digital watermark, so as to monitor whether the tone quality of the broadcast audio signal is normal or not.

7. The method for monitoring tone quality of a broadcast system as claimed in claim 6, wherein the step of extracting the digital watermark and comparing the extracted digital watermark with the original digital watermark comprises:
recording the broadcast audio signal, and generating a recording file;
extracting the digital watermark from the recording file, and comparing the extracted digital watermark with the original digital watermark, so as to generate a comparison value;
determining the tone quality of the broadcast audio signal is normal, if the comparison value is higher than a threshold value; and
determining the tone quality of the broadcast audio signal is abnormal, if the comparison value is lower than the threshold value.

8. The method for monitoring tone quality of a broadcast system as claimed in claim 6, wherein the broadcast system comprises an FM broadcast system, an AM broadcast system, a network broadcast system, and a network television broadcast system.

9. The method for monitoring tone quality of a broadcast system as claimed in claim 6, wherein the digital watermark is an audio signal.

10. An equipment for monitoring tone quality of an audio player, comprising:
a watermark embedding module, generating an audio signal embedded with a digital watermark for the audio player to play; and
an analysis module, recording the audio signal played by the audio player, extracting the digital watermark, and analyzing relative parameters of the tone quality of the audio player based on the comparison between the extracted digital watermark and the original digital watermark.

11. The equipment for monitoring tone quality of an audio player as claimed in claim 10, wherein the watermark embedding module comprises:
an audio signal generating unit, generating an original audio signal;
a watermark generating unit, generating the digital watermark; and
a mixing unit, coupled to the audio signal generating unit and the watermark generating unit, for embedding the digital watermark into the original audio signal.

12. The equipment for monitoring tone quality of an audio player as claimed in claim 10, wherein the original audio signal is a digital audio signal.

13. The equipment for monitoring tone quality of an audio player as claimed in claim 10, wherein the analysis module comprises:
a recording unit, recording the audio signal played by the audio player, and saving the audio signal as a recording file;
an extracting unit, coupled to the recording unit, for extracting the digital watermark from the recording file; and
a comparison unit, coupled to the extracting unit, for comparing the extracted digital watermark with the original digital watermark, so as to monitor relative parameters of the tone quality of the audio signal.

14. The equipment for monitoring tone quality of an audio player as claimed in claim 10, wherein the relative parameters of the tone quality of the audio signal comprise frequency response, total harmonic distortion plus noise (THD+N), amplitude, frequency accuracy, and noise saturation.

15. The equipment for monitoring tone quality of an audio player as claimed in claim 10, wherein the digital watermark is a numerical sequence.

16. An equipment for monitoring tone quality of a broadcast system, comprising:
a watermark embedding module, for embedding a digital watermark into a broadcast audio signal broadcasted by the broadcast system; and
an analysis module, recording the broadcast audio signal, extracting the digital watermark, and analyzes whether the tone quality of the broadcast audio signal is normal or not based on the comparison between the extracted digital watermark and the original digital watermark.

17. The equipment for monitoring tone quality of a broadcast system as claimed in claim 16, wherein the watermark embedding module comprises:
a watermark generating unit, generating the digital watermark; and
a mixing unit, embedding the digital watermark into the digital broadcast audio signal.

18. The equipment for monitoring tone quality of a broadcast system as claimed in claim 16, wherein the analysis module comprises:
a recording unit, recording the broadcast audio signal, and saving the broadcast audio signal as a recording file;
an extracting unit, coupled to the recording unit, for extracting the digital watermark from the recording file; and
a comparison unit, coupled to the extracting unit, for comparing the extracted digital watermark with the original digital watermark, so as to monitor the tone quality of the broadcast audio signal.

19. The equipment for monitoring tone quality of a broadcast system as claimed in claim 16, wherein the broadcast system comprises an FM broadcast system, an AM broadcast system, a network broadcast system, and a network television broadcast system.

20. The equipment for monitoring tone quality of a broadcast system as claimed in claim 16, wherein the digital watermark is a numerical sequence.
